(19) United States
(12) Patent Application Publication
(10) Pub. No.: US 2013/0088095 A1
(43) Pub. Date: Apr. 11, 2013

(54) METHOD AND SYSTEM FOR THE REMOTE CONTROL OF AN ELECTRICAL CONSUMER

(71) Applicant: Andreas Martschitsch, Bern (CH)

(72) Inventor: Andreas Martschitsch, Bern (CH)

(21) Appl. No.: 13/646,248

(22) Filed: Oct. 5, 2012

(30) Foreign Application Priority Data
Oct. 5, 2011 (EP) 11183896.7
Aug. 17, 2012 (EP) 12180806.7

(51) Int. Cl. H01H 47/00

(52) U.S. Cl. 307/126

(57) ABSTRACT

A method for remote control of an electric consumer end device with a power adapter, for switching supply of power of the electric consumer on and off, whereby a central e-server may select, depending on the automatically recognized type of the electric consumer end device, a power-saving profile assigned to the type of the electric consumer, and may control the power adapter depending on the selected power-saving profile, where the control comprises causing the power adaptor to switch the supply of power of the consumer end device on or off based on the power-saving profile.

### CLAIM OF PRIORITY AND CROSS-REFERENCE TO RELATED APPLICATIONS/INCORPORATION BY REFERENCE

Pursuant to 35 U.S.C. §119, this patent application claims the filing date benefit of and right of priority to European (EP) Application No. 11183896.7, which was filed on Oct. 5, 2011; and European (EP) Application No. 12180806.7, which was filed on Aug. 17, 2012.

Each of the above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

The present invention relates to electrical devices. More specifically, certain embodiments of the invention relate to method and system for the remote control of an electric consumer.

### BACKGROUND OF THE INVENTION

Solutions are known in the state of the technology for the remote control of electronic devices or for switching such devices on or off after a certain time, for example in order to save electricity. Thus EP2105822 describes an electronic device, for example a video recorder, which determines information concerning a television program through “Internet signals” and accordingly switches itself on or off.

GB2384926 describes a set-top box or a video recorder with a timer in order to automatically switch the device on or off at predetermined times. These times can be determined with an Electronic Program Guide (EPG), or they can be selected such that the devices will not be switched off during a recording process.

US20070173221 discloses the switching on and off of a set-top box depending on the battery capacity and the length of the broadcast program. If the battery is not sufficiently charged, priorities among various broadcast programs can be used to determine the program to be recorded. The data of an EPG can be taken into consideration for the control.

US20060109384 discloses a sensor that monitors the power consumption of a television set to determine whether a video recorder should be switched on or off.

GB2443454 discloses a sensor that monitors the power consumption of a television set in order to switch it and other devices completely off when it is in standby mode.

The article “Enabling Applicability of Energy Saving Applications on the Appliances of the Home Environment” by Spyridon Tompros, Nikolaos Mouratidis, Maurice Draaijer, Andreas Foglar and Halid Hrasnica, published in IEEE Network, November/December 2009, pages 8 through 16, discloses a software solution for the measurement of energy consumption. Instead of physically measuring energy consumption, the current program state is queried in a consumer end device and the energy consumption in this program state is looked up in a profile of the consumer. On the basis of the consumption thus determined of all consumer end devices in a household, individual consumer end devices are switched over or completely switched off if the consumption of the entire household exceeds a maximum amount.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for the remote control of an electrical consumer, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

Various features and advantages of the invention will become apparent from the following description of non-limiting exemplary embodiments, with reference to the appended drawings, in which:

FIG. 1 illustrates a system for remote control, in accordance with the invention.

### DETAILED DESCRIPTION OF THE INVENTION

Certain embodiments of the present invention may be found in a method and system for the remote control of an electrical consumer, as described in the following in more detail with reference to the attached figures.

As utilized herein, the term “exemplary” means serving as a non-limiting example, instance, or illustration.

Aspects of the invention provide for saving energy in, and central control, of household devices. More particularly, aspects of the present invention enable a user to control his household devices either manually or automatically through remote control, and to obtain an overview of the energy consumption of his household devices, thereby providing the user an opportunity to lower energy consumption.

Aspects of the present invention provide a method and/or a system for remote control of electric consumer end devices, with each having a power adapter for switching the supply of energy of the electrical consumer end device assigned to the power adapter on and off. In this regard, a central e-server may control switching the power supply of the assigned consumer end devices on or off. In particular, the central e-server may select, depending on the automatically recognized type of the electric consumer end device, a stored power-saving profile assigned to the type of the electric consumer end device, and may control the power adapter depending on the selected power-saving profile such that the supply of power of the electric consumer end device is switched on or off in accordance with the power-saving profile. The power-saving profile contains the control of the supply of power of the electric consumer end device. The electric consumer end device may be, for example and without limitation, a refrigerator, a video recorder, a set-top box, a stereo system, a TV, or an Internet-based TV.

In one exemplary embodiment, the power adapter may measure the power consumption of the electric consumer end device and may transmit the data of the power adapter to the central e-server on a continuous or periodic basis.

In one exemplary embodiment, the central e-server may determine the type of the electric consumer end device. The type of the electric consumer end device may be determined, by way of example, on the basis of the measured power consumption of the electric consumer end device. Alternatively, the type of the electric consumer end device may be determined on the basis of protocols. The type of the electric consumer end device may also be provided by a customer to the central e-server.

In one exemplary embodiment, the central e-server may store consumption data of the electric consumer end device in a databank.

In one exemplary embodiment, the central e-server may contact a second server, and may determine when the electric consumer end device is supposed to be switched on.

In one exemplary embodiment, a customer may switch the supply of power to a consumer end device on by accessing the central e-server through the Internet or through a mobile wireless network, and inputting a corresponding command.

In one exemplary embodiment, the central e-server and the power adapter may communicate with each other through the Internet or a LAN.

In one exemplary embodiment, the power-saving profile may contain the control of the supply of power of the electric consumer end device which reduces the power consumption through targeted switching on and off without the actual function of the electric consumer end device which is being impaired.

In one exemplary embodiment, power adapter may have a housing with a plug for connection with the power supply and an outlet for connection with electric consumer end device. The power adapter thus may be used for a multiplicity of electric consumer end devices.

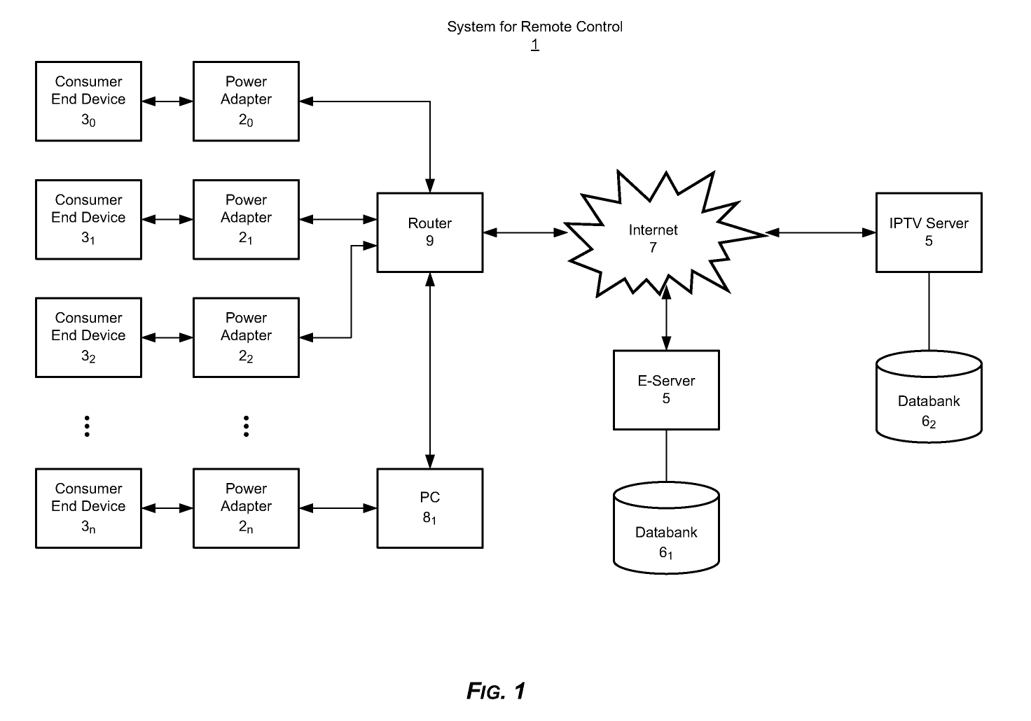

FIG. 1 illustrates an exemplary system (1) for remote control, in accordance with the invention. In this regard, the system (1) may comprise a plurality of consumer end devices 3₀, 3₁, 3₂, . . . , 3ₙ, each of which may be connected to a power adapter 2₀, 2₁, 2₂, . . . , 2ₙ. Each of the power adapters 2₀, 2₁, 2₂, . . . , 2ₙ may comprise suitable circuitry, interfaces, logic, and/or code for enabling performing a plurality of tasks, and in particular to switch the power supply for the assigned power adapter on and off. For this purpose, the power adapters 2₀, 2₁, 2₂, . . . , 2ₙ may be connected between the power supply and the electric consumer end devices (3₀, 3₁, 3₂, . . . , 3ₙ). In one exemplary embodiment, the power adapters 2₀, 2₁, 2₂, . . . , 2ₙ may be configured as hardware. Such a power adapter may have a housing with a plug for connection with the power supply and an outlet for connection with electric consumer end device (one of the devices 3₀, 3₁, 3₂, . . . , 3ₙ) assigned to the power adapter. The plug and the outlet of a power adapter (2₀, 2₁, 2₂, . . . , 2ₙ) may be connected to each other for the conduction of the current, by way of example, through a cooper cable. The power adapters 2₀, 2₁, 2₂, . . . , 2ₙ may also have several plugs for connection with several electric consumer end devices (3₀, 3₁, 3₂, . . . , 3ₙ). Alternatively, the power adapter 2₀, 2₁, 2₂, . . . , 2ₙ may also be integrated into an electric consumer end device (3₀, 3₁, 3₂, . . . , 3ₙ). In one such exemplary embodiment, the power adapter 2₀, 2₁, 2₂, . . . , 2ₙ may only one plug. The power adapter 2₀, 2₁, 2₂, . . . , 2ₙ may be connected directly, that is without an outlet, to the power input of the consumer end devices (3₀, 3₁, 3₂, . . . , 3ₙ). In another exemplary embodiment, however, it is also possible to realize power adapter (2₀, 2₁, 2₂, . . . , 2ₙ) as software that may be arranged in the electric consumer end device (3ₒ, 3₁, 3₂, . . . , 3ₙ) and/or in some other central unit of the household network. Three consumer end devices (3₀, 3₁, and 3₂), each with a power adapter (2₀, 2₁, and 2₂), are depicted in FIG. 1. However, this was done only for illustrative purposes. In the framework of the invention, the number of consumer end devices is not limited in any manner. In the framework of the invention, it is also possible for multiple consumer end devices 3₀, 3₁, 3₂, . . . , 3ₙ to be connected to a single power adapter (e.g., power adapter 2₀), for example if it is configured as a power strip, not depicted.

In general, the electric consumer end devices 3₀, 3₁, 3₂, . . . , 3ₙ may correspond to household devices. In particular, refrigerators, video recorders, set-top boxes, stereo systems, TVs, Internet-based TVs, coffee machines, lamps, etc., are possible in the framework of the present invention. Generally, it can also be household devices that can be switched off in order in this way to save power (and for example to avoid the standby mode) without impairing the actual functioning of the device; thus, for example, refrigerators can be switched off as soon as so doing does not exceed a certain period of time and the cooling function may be ensured. The electric consumer end devices are not restricted in the framework of the invention to household devices, but rather can be electric devices of any type, including office devices for example.

The power adapters 2₀, 2₁, 2₂, . . . , 2ₙ may measure the power consumption of connected consumer end devices 3₀, 3₁, 3₂, . . . , 3ₙ, such as on a continuous basis, and may send the data of power consumption to a central e-server 4. In this regard, the central e-server 4 may comprise suitable circuitry, interfaces, logic, and/or code for performing a plurality of tasks and/or functions, to implement various aspects of the invention. The power adapters 2₀, 2₁, 2₂, . . . , 2ₙ receive a sensor for measuring the power consumption. The data can be sent to the central e-server 4 continuously and in real time or at predefined time intervals. The power adapters communicate with the central e-server 4 via a router 9. Depending on the embodiment variant, the power adapters 2₀, 2₁, 2₂, . . . , 2ₙ may communicate with the router 9 via a cabled network (for example LAN, power network) or a wireless network, for example a wireless LAN. For the connection of the power adapter 2₀, 2₁, 2₂, . . . , 2ₙ to a network other than the power network, the power adapter 2₀, 2₁, 2₂, . . . , 2ₙ may have an interface for connection with the network. The router functionality can also be present in power adapter 2. The data from all connected power adapters 2₀, 2₁, 2₂, . . . , 2ₙ may be stored in a databank 6₁, which may be connected to the central e-server 4 or to a portion of it. The data may contain in particular the measured power consumption of the consumer end devices 3₀, 3₁, 3₂, . . . , 3ₙ connected with the respective power adapters 2₀, 2₁, 2₂, . . . , 2ₙ. The central e-server 4 may be network-based, and communication between the power adapters 2₀, 2₁, 2₂, . . . , 2ₙ and the central the central e-server 4 occurs, by way of example, through the Internet 7. However, it may also be possible that the central e-server 4 be arranged in the household network (e.g., a LAN or power network), and communication between the power adapters 2₀, 2₁, 2₂, . . . , 2ₙ and the central e-server 4 may occur through the LAN or power network. The basic function of the central e-server 4 may be the control (the switching on and off) of the supply of power to individual consumer end devices 3₀, 3₁, 3₂, . . . , 3ₙ through the issuance of a corresponding command to the corresponding power adapters 2₀, 2₁, 2₂, . . . , 2ₙ. The conduction of power to the electric consumer end devices 3₀, 3₁, 3₂, . . . , 3ₙ by the power adapter power adapters 2₀, 2₁, 2₂, . . . , 2ₙ may, in an exemplary embodiment, be also manually switched on and off directly at the adapter, for example through a switch affixed to the power adapters 2₀, 2₁, 2₂, . . . , 2ₙ. In this way, the automatic, server-based control can be manually overridden by the user.

The central e-server 4, on the basis of the consumption data such as through analysis or data mining procedures, may determine the type of the electric consumer end device precisely (e.g., that it is refrigerator AEG 234-23) or as precisely as possible (e.g., just that it is refrigerator). In another exemplary embodiment, the central e-server 4 may also determine the type of device, by way of example, on the basis of protocols, e.g., via Universal Plug and Play (UPnP). In so doing, the central e-server 4 may recognize the type of the electric consumer end device on the basis of information sent through the power network by the consumer end device. The databank 6₁ may contain, for example, a power-saving profile for each of a multiplicity of types of electric consumers. In particular, the power-saving profile may contain data regarding how power consumption of this type of electric consumer can be reduced through targeted switching on and off. In one exemplary embodiment, it may be determined by means of the power-saving profile of a particular type of electric consumer end device how the supply of power to such an electric consumer end device can be periodically switched on and off in order to maintain the function of the electric consumer end device even during the switched-off period. In another exemplary embodiment, the data contains the times during which the consumer end device, as a rule, may not be used (e.g., during the night between midnight and 6:00 a.m., etc.), and thus can be switched off. Based on the type of the electric consumer end device and the data stored in databank 6₁, the central e-server 4 knows how the power consumption of each individual consumer end device 3₀, 3₁, 3₂, . . . , 3ₙ can be additionally reduced through intelligent control of the supply of power (targeted switching on and off). The connection between individual power adapters 2₀, 2₁, 2₂, . . . , 2ₙ and the central e-server 4 may also be established through a personal computer (PC) 8₁ and the router 9 of the customer, for example through a USB port and/or through a wireless connection. The PC 8₁ may receive the data that are transmitted by the intelligent power adapters 2₀, 2₁, 2₂, . . . , 2ₙ, and may send them preferably in real time to the central e-server 4. The central e-server 4 may save the data in the databank 6₁ and makes them visible in a personal Internet-based portal of the user.

Exemplary embodiment 1: refrigerator. In an embodiment the consumer end device may be a refrigerator. In this regard, the central e-server 4 may determine on the basis of the transmitted consumer data that the connected electric consumer end device (e.g., the consumer end device 3₀) is, by way of example, an AEG 234-23 refrigerator. On the basis of the power-saving profile stored for this type, the central e-server 4 may determine how the refrigerator, for example consumer end device 3₀, can be additionally switched on and off (e.g., continuously one hour on and then 30 minutes off) in order to further reduce energy consumption. In this manner, the power consumption may be reduced but the function of the refrigerator may not be restricted.

From the transmitted data, it creates a control profile. The central e-server 4 may transmit the control data to the corresponding power adapter (e.g., the power adapter 2₀), which may carry out the switching-on and switching-off processes.

In some instances, a second server 5, which may be an IPTV or WebTV server, with a (second) customer databank 6₂ may be used. In this regard, the acronym “IPTV” stands for “Internet Protocol Television.” TV content may be transmitted to the end customer through a shielded network via Internet 7 and may be displayed by means of a set-top box (e.g., end device 3₂), by way of example, on a TV (as electric consumer end device 3₁). To this end, the customer may have a certain subscription with the IPTV provider. If a recording is programmed, the IPTV server 5 can inform the central e-server 4 that the supply of power to the set-top box or a video recorder of the customer is to be activated. The connection between servers 4 and 5 can be accomplished via the Internet 7, as well as, by way of example, through a LAN (not depicted). After successful recording, the power supply of electric consumer end device 3₁ may be switched off again by means of power adapter 2₁.

In some instances, a customer may switch on the supply of power to an electric consumer end device (e.g., one of the electric consumer end devices 3₀, 3₁, 3₂, . . . , 3ₙ), by accessing the central e-server 4 through the Internet 7, or through a mobile wireless network, and manually inputting a corresponding command. In addition, the central e-server 4 can be reached through the aforementioned personal Internet-based portal (website) with the PC 8₁ where the customer can on a view his own personalized power adapters 2₀, 2₁, 2₂, . . . , 2ₙ and the transmitted power consumption of assigned electric consumer end devices 3₀, 3₁, 3₂, . . . , 3ₙ and if appropriate additional information. Through this connection, the customer can also input appropriate changes of the electric consumer end devices 3₀, 3₁, 3₂, . . . , 3ₙ, or brand or type data relating thereto, or may likewise program the control of the switching on and off of his devices according to an individual time schedule. The customer can likewise have access to the website of the central e-server 4 through an Internet-based mobile wireless connection. The website of the central e-server 4 can likewise provide access to individual recommendations relating to the transmitted measured data of the energy consumption of the customer and offer exchange of information through a network of energy professionals as well as through his social network (e.g., friends, family, etc.).

Exemplary embodiment 2: set-top box. In an embodiment the electric consumer end device may be a set-top box. In this regard, on the basis of transmitted electric consumer data, the central e-server 4 may determine that the connected electric consumer end device (e.g., electric consumer end device 3₁) is a set-top box, by way of example, of the type Cisco 2345-AB. Alternatively, the customer may manually inform the central e-server 4 at the time of installation and set-up of the power adapter that the customer has connected a set-top box of this type. On the basis of the power-saving profile stored for this type, the central e-server 4 may determine that the supply of power to the set-top box can always be interrupted at a time when it is in standby mode and no recordings are in progress. The customer may register on the central e-server 4, using IPTV account data for example. The central e-server 4 may contact the IPTV server 5, and may determine when the next recording is supposed to take place. Alternatively, the IPTV server 5 may contact the central e-server 4, and may informs it when the next recording is supposed to take place. If the supply of power to the electric consumer end device was interrupted by the central e-server 4, which may now switch the set-top box on again shortly before a time which can be set so that it will be ready for the recording. Since the central e-server 4 on the basis of the data exchanged with the IPTV system (by communicating with the IPTV server 5) may know how long a recording will be running, the electric consumer end device can be switched off again afterwards. If the customer would like to use the set-top box while the supply of power to the set-top box is interrupted, the customer may access the central e-server 4 via a smartphone application through a mobile wireless network or via a Web application through the customer's PC (8₁) and the Internet 7 and switch the set-top box on again within fractions of a second.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein.

Accordingly, the present invention may be realized in hardware, software, or a combination of hardware and software. The present invention may be realized in a centralized fashion in at least one computer system, or in a distributed fashion where different units are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for remote control of an electric consumer end device with a power adapter for switching supply of power of the electric consumer end device, comprising:
selecting by a central e-server, depending on an automatically recognized consumer type of the electric consumer end device, a power-saving profile assigned to the type of the electric consumer end device; and
controlling the power adapter depending on the selected power-saving profile, wherein the controlling comprises causing the power adaptor to switch the supply of power of the consumer end device on or off.

2. The method of claim 1, comprising:
causing the power adapter to measure power consumption of the connected electric consumer end device; and
receiving the data of the power adapter by the central e-server on a continuous or periodic basis.

3. The method of claim 1, comprising determining by the central e-server the type of the electric consumer end device.

4. The method of claim 3, comprising determining by the central e-server the type of the electric consumer end device on the basis of the measured power consumption of the electric consumer end device.

5. The method of claim 3, comprising determining by the central e-server the type of the electric consumer end device on the basis of protocols.

6. The method of claim 1, wherein the type of the electric consumer end device is received by the central e-server from a customer.

7. The method of claim 1, comprising storing by the central e-server consumption data of the electric consumer end device in a databank.

8. The method of claim 1, comprising contacting by the central e-server a second server to determines when the electric consumer end device is supposed to be switched on.

9. The method of claim 1, wherein central e-server causes the power supply to be switched on responsive to a communication from a customer via the Internet or via a mobile wireless network.

10. The method of claim 1, wherein the central e-server and the power adapter are configured to communicate with each other through the Internet or a LAN.

11. The method of claim 1, wherein the power-saving profile comprises a control of the power supply of the electric consumer end device which reduces the power consumption of the electric consumer end device through targeted switching on and off of the electric consumer end device without impairing the actual function of the electric consumer end device.

12. A system, comprising:
a central e-server for remote control of an electric consumer end device with a power adapter for switching the supply of power of the electric consumer end device on and off, wherein the central e-server is configured to:
select, depending on an automatically recognized type of the electric consumer end device, a power-saving profile assigned to the type of the electric consumer end device;
control the power adapter depending on the selected power-saving profile, wherein the control comprises causing the power adaptor to switch the supply of power of the consumer on or off.

13. The system of claim 12, wherein the central e-server is configured to:
cause the power adapter to measure power consumption of the connected electric consumer end device; and
receive the data of the power adapter by the central e-server on a continuous or periodic basis.

14. The system of claim 12, wherein the central e-server is configured to determine the type of the electric consumer end device.

15. The system of claim 14, wherein the central e-server is configured to determine the type of the electric consumer end device on the basis of the measured power consumption of the electric consumer end device.

16. The system of claim 14, wherein the central e-server is configured to determine the type of the electric consumer end device on the basis of protocols.

17. The system of claim 12, wherein the central e-server is configured to receive the type of the electric consumer end device from a customer.

18. The system of claim 12, wherein the central e-server is configured to store consumption data of the electric consumer end device in a databank.

19. The system of claim 12, wherein the central e-server is configured to contact a second server to determines when the electric consumer end device is supposed to be switched on.

20. The system of claim 12, wherein the central e-server is configured to cause the power supply to be switched on responsive to a communication from a customer via the Internet or via a mobile wireless network.

21. The system of claim 12, wherein the power adapter and the central e-server are connected through the Internet or a LAN and can communicate through it.

22. The system of claim 12, wherein the electric consumer end device is a refrigerator, a video recorder, set-top box, a stereo system, a TV, or an Internet-based TV.

23. The system of claim 12, wherein the power adapter has a housing with a plug for connection with the power supply and an outlet for connection with electric consumer end device.
